(19) United States
(12) Patent Application Publication
(10) Pub. No.: US 2016/0142008 A1
(43) Pub. Date: May 19, 2016

(54) Photovoltaic Devices With Improved Connector and Electrical Circuit Assembly

(71) Applicant: DOW GLOBAL TECHNOLOGIES LLC, Midland, MI (US)

(72) Inventors: Leonardo C. LOPEZ, Midland, MI (US); James R. KEENIHAN, Midland, MI (US); Joseph A. LANGMAID, Caro, MI (US)

(73) Assignee: Dow Global Technologies LLC, Midland, MI (US)

(21) Appl. No.: 14/902,950

(22) PCT Filed: Jul. 21, 2014
(86) PCT No.: PCT/US14/47353

§ 371 Date: Jan. 5, 2016

Related U.S. Application Data
(60) Provisional application No. 61/861,152, filed on Aug. 1, 2013.

(51) Int. Cl. H02S 40/36

(52) U.S. Cl. CPC H02S 40/36

(57) ABSTRACT

Photovoltaic devices 2 containing connector assemblies 10 and connector electrical circuit assemblies 5 having enhanced sealing about electrical components, enhanced adhesion between components of dissimilar materials and enhanced structural integrity and strength.

### NOTICE OF US GOVERNMENT SUPPORT

This invention was made with U.S. Government support under contract DE-EE-0004344 awarded by the Department of Energy. The U.S. Government has certain rights in this invention.

### FIELD OF THE INVENTION

The present invention relates to an improved connector and electrical circuit assembly for improved wet insulation resistance, adhesion of components and structural integrity of the assembly, more particularly an assembly that is at least partially encased within a polymeric frame.

### BACKGROUND

BIPV products (also known as “Building Integrated Photovoltaics” or BIPV) are exposed to significant variations in environmental loadings. They are preferably located in direct sunlight where they are subject to additional temperature loadings (beyond daily and seasonal ambient swings) due to radiant cooling and heating and may be exposed to various environmental conditions, such as rain and wind, snow and ice and other stressful environmental conditions. Such conditions can impact the ability of the systems to function as desired if certain parts are not protected from these environmental conditions for the lifetime of the product. The BIPV system design needs to address the impacts of these environmental conditions including ensuring good electrical contacts within and among components of the system.

Various testing protocols (e.g. UL 1703 Wet Insulation Resistance test (“Wet Hi-pot”) are used to determine the product's capability to handle these temperature variations. Similarly, the environment in which the photovoltaic devices are mounted to may change as a function of temperature, humidity, or as the structure settles with time. In cases where the photovoltaic devices have integral connectors and may not connected with wires or flexible members there is a possibility of leakage paths at these integral device to device connections if not properly designed or installed. An example of available solutions is illustrated in commonly owned patent application WO 2012/044762 which discloses a connector and electrical circuit assembly at least partially encased in a polymeric frame, including at least a connector assembly, the connector assembly including at least a connector housing; at least one electrical connector protruding from the housing; an electrical circuit component comprising; at least one bus bar; and a connection zone where the at least one electrical connector and the at least one bus bar are joined; wherein the connection zone, the connector housing, or both including at least one elastomeric barrier element, incorporated herein by reference in its entirety.

What is needed is a connector assembly, such connector assembly and an electrical circuit assembly, that can be at least partially encased within a polymeric frame and building integrated photovoltaic devices containing such assemblies which address the needs described herein. It is desirable that such assemblies and devices provide sealing about the electrical systems to prevent degradation of the system's ability to transmit electrical current, enhanced adhesion between the various components and enhanced structural stability and integrity.

### SUMMARY OF THE INVENTION

The present invention is directed to photovoltaic devices containing connector assemblies and connector electrical circuit assemblies having enhanced sealing about electrical components, enhanced adhesion between components of dissimilar materials and enhanced structural integrity and strength.

In one aspect the invention relates to a photovoltaic device comprising: a polymeric frame; one or more photovoltaic cells that include one or more electrical circuit assemblies; one or more connector assemblies comprising i) a connector housing having an inboard portion, an outboard portion and a header that separates the inboard portion from the outboard portion; ii) at least one electrical conductor having one end located at least partially within the outboard portion of the one or more connector assemblies and a second end protruding from the inboard portion of the housing wherein the second end is connected to one of the electrical circuit assemblies, iii) a sealant disposed about at least a portion of the inboard portion of the connector housing; and iv) a rigid case disposed about and containing the sealant; wherein the one or more connector assemblies and the one or more electrical circuit assemblies are at least partially encased in the polymeric frame.

In another aspect, the invention relates to a method comprising; a) connecting at least one of the electrical conductors of one or more connector assemblies to the one or more electrical circuit assemblies of one or more photovoltaic cells wherein the connector assemblies comprise a connector housing having an Inboard portion, an outboard portion and a header that separates the inboard portion from the outboard portion and the at least one electrical conductor having one and located at least partially within the outboard portion of the one or more connector assemblies and a second end protruding from the inboard portion of the connector housing wherein the second end is connected to the electrical circuit assembly; b) contacting sealant with a portion of the connector housing, optionally the second end of electrical conductor protruding from the inboard portion of the connector housing and optionally the connection between the electrical connector and one of the electrical circuit assemblies so as to form a seal about the contacted portions with the sealant; c) contacting a rigid case with the sealant; d) encasing the sealant with the rigid case wherein the sealant is disposed about a portion of the connector housing, optionally the second end of electrical conductor protruding from the inboard portion of the connector housing and optionally the connection between the electrical connector and one of the electrical circuit assemblies, so as to form a seal about the contacted portions with the sealant; and e) forming a polymeric frame about a portion of the one or more photovoltaic cells and the one or more connector assemblies. Such method may be utilized to manufacture building integrated devices.

### DESCRIPTION OF THE DRAWINGS

FIG. 1 is a view of an illustrative example of a photovoltaic device according to the present invention.

FIG. 2 is an exploded view of a photovoltaic device of FIG. 1.

FIG. 3 is a view of one illustrative example of a connector and electrical circuit assembly according to the present invention.

FIG. 4 is a view of the illustrative example of the connector and electrical circuit assembly of FIG. 3 along line A-A.

FIG. 5 is a view of another illustrative example of an Improved connector and electrical circuit assembly according to the present invention

FIG. 6 is a view of a two part rigid case useful in the assemblies according to the present invention.

FIG. 7 is a view of another rigid case useful in the assemblies according to the present invention.

### DETAILED DESCRIPTION OF THE PREFERRED EMBODIMENT

The present invention is directed to an improved connector and electrical circuit assembly that is at least partially encased in a polymeric frame. Of particular interest in this application is an improved connector and electrical circuit assembly that is part of a photovoltaic device (“PV device”), for example as described in PCT Patent Application No. PCT/US2009/042523, incorporated herein by reference. This application claims priority from U.S. Provisional Application Ser. No. 61/861,152 filed Aug. 1, 2013 incorporated herein by reference in its entirety. The photovoltaic device, for the purposes of the present invention, can be generally defined as comprising one or more known photovoltaic cells end the structure disposed about the photovoltaic cells to facilitate mounting the photovoltaic cells on a structure, such as a building or array support structure. In a preferred embodiment the photovoltaic device is comprises a multi-layer laminate structure that is at least partially encased in a polymeric frame. In a preferred embodiment the polymeric frame is formed about the photovoltaic cell or cells via a molding process, such as an over-molding process. The improved connector and electrical circuit assembly is electrically connected to one or more of the photovoltaic cells. It may be convenient to assemble these components as part of the multi-layer laminate structure. The respective components of the photovoltaic device are further described below. In a preferred embodiment the photovoltaic devices are building integrated devices, meaning that they are attached directly to a structure. Preferably such photovoltaic devices are designed to look like standard roofing materials and can be disposed on the same structure as standard roofing materials. Preferably the photovoltaic devices can be attached to a structure in the same manner as standard roofing materials. For instance the photovoltaic devices can have the appearance of roofing shingles or tiles and can be attached to a structure in the same manner. When the photovoltaic devices are designed to function in the same manner as shingles, such devices can be attached directly to a roof or sheathing element over a roof using standard fastening systems such as nails, screws, staples, adhesives and the like. The devices of the invention are preferably sufficiently flexible to conform to irregularities in the surface of the structure to which they are attached.

### Multi-Layer Laminate Structure

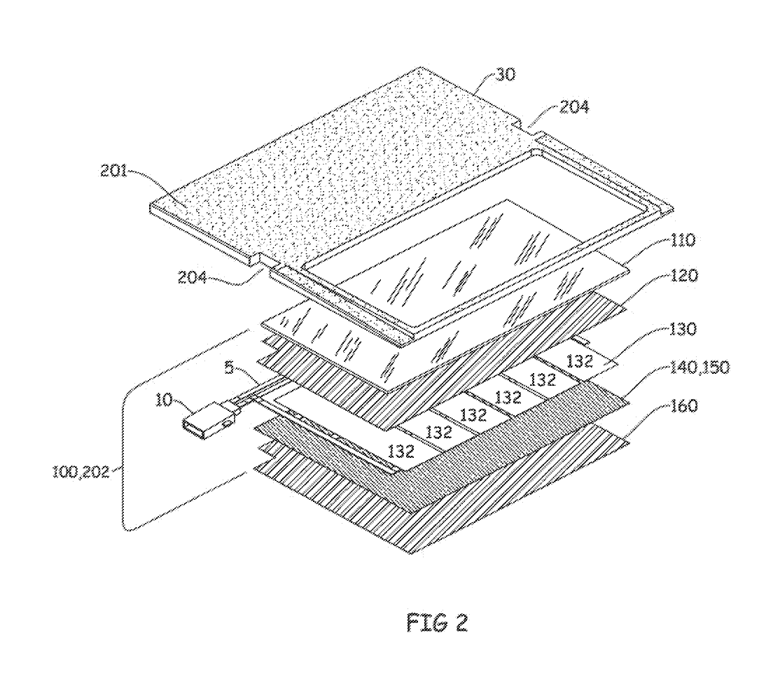

In a preferred embodiment the photovoltaic devices of the invention comprise a multilayer laminate structure. The multi-layer laminate structure, for example as shown in FIG. 2, may include a plurality of individual layers (e.g. first layer, second layer, third layer, or more) which are at least partially bonded together to form the multi-layer laminate structure. In the assembled multi-layer laminate structure, any given layer may at least partially interact/interface with more than just its adjacent layer (e.g. first layer may interact/interface at least partially with the third layer). Each individual layer may be defined as having a height, length and width, and thus a volume. Each layer may also have a profile that is consistent along its height, length or width or may be variable therein. Each layer may have top, bottom, and interposed side surfaces. Each individual layer may be monolithic in nature or may itself be a multi-layer construction or an assembly of constituent components. Various layer construction/compositions embodiments are discussed below. It should be appreciated that any layer of the multi-layer laminate structure may contain any or none of the materials or assemblies. In other words, any particular layer embodiment may be part of any of the layers of the multi-layer laminate structure.

One or more of the layers may function as an environmental shield (“shield layer”), for the multi-layer laminate structure generally, and more particularly as an environmental shield for the successive layers. This layer functions to protect one or more of the other layers from exposure to the elements or any material that can damage other layers or interfere in the other layers ability to function as desired. This layer is preferably constructed of a transparent or translucent material that allows light energy to pass through to at least one underlying layer. This material may be flexible (e.g. a thin polymeric film, a multi-layer film, glass, or glass composite) or be rigid (e.g. a thick glass or Plexiglas™ such as polycarbonate). The material may also be characterized by being resistant to moisture/particle penetration or build up. The environmental shield layer may also function to filter certain wavelengths of light such that preferred wavelengths may readily reach the opposite side of that layer, e.g. photovoltaic cells below the shield layer. The environmental shield layer may also function as a dielectric layer to provide electrical insulation between the electrically active materials contained within the multi-layer laminate structure and the environment so as to provide protection to both the electrically active materials and externally interfacing elements. In a preferred embodiment, the environmental shield layer (first) layer material will also range in thickness from about 0.05 mm to 10.0 mm, more preferably from about 0.1 mm to 4.0 mm, and most preferably from about 0.2 mm to 0.8 mm. Other physical characteristics, at least in the case of a film, may include: a tensile strength of greater than 20 MPa (as measured by JIS K7127: JSA JIS K 7127 Testing Method for Tensile Properties of Plastic Films and Sheets published in 1989); tensile elongation of 1% or greater (as measured by JIS K7127); and water absorption (23° C., 24 hours) of 0.05% or less (as measured per ASTM D570-98(2005)).

In a preferred embodiment, one or more of the layers may serve as a bonding mechanism (bonding layer), helping hold some or all of any adjacent layers together. In some case (although not always), it should also allow the transmission of a desirous amount and type of light energy to reach adjacent layers. The bonding layer may also function to compensate for irregularities in geometry of the adjoining layers or translated though those layers (e.g. thickness changes). It also may serve to allow flexure and movement between layers due to temperature change and physical movement and bending. In a preferred embodiment, the bonding layer may comprise an adhesive film or mesh, preferably an olefin (especially functionalized olefins such as silane grafted olefins), EVA (ethylene-vinyl-acetate), silicone, PVB (poly-vinyl-butyral) or similar material. The preferred thickness of this layer range from about 0.1 mm to 1.0 mm, more preferably from about 0.2 mm to 0.8 mm, and most preferably from about 0.25 mm to 0.5 mm.

In a preferred embodiment, one or more of the layers may also serve as a second environmental protection layer (back sheet layers), for example to keep out moisture and/or particulate matter from the layers above (or below if there are additional layers). It is preferably constructed of a flexible material (e.g. a thin polymeric film, a metal foil, a multi-layer film, or a rubber sheet). In a preferred embodiment, the back sheet material may be moisture impermeable and also range in thickness from about 0.05 mm to 10.0 mm, more preferably from about 0.1 mm to 4.0 mm, and most preferably from about 0.2 mm to 0.8 mm. Other physical characteristics may include: elongation at break of about 20% or greater (as measured by ASTM D882-09); tensile strength or about 25 MPa or greater (as measured by ASTM D882-09); and tear strength of about 70 kN/m or greater (as measured with the Graves Method). Examples of preferred materials include glass plate, PET, aluminum foil, Tedlar® (a trademark of DuPont) or a combination thereof.

In a preferred embodiment, one or more of the layers may also serve as dielectric layers. These layers may be integrated into other layers or exist as independent layers. The function of these layers is to provide electrical separation between the electrically active materials contained within the multi-layer laminate system and other electrically active materials also within the multi-layer laminate system, or elements outside of the multi-layer laminate system. Stated another way, a dielectric material functions to prevent leakage of current into areas of the photovoltaic devices that can be damaged as a result of the leakage or where the functioning of the devices can be compromised. Two main factors that impact the ability of a material to function as a dielectric layer is the inherent resistance, high resistance, to current flow through the material and the thickness of the material. Thus to form an effective dielectric layer the balance of a materials resistance and the material thickness is utilized to provide the desired dielectric properties (insulating properties). Thus it is preferable that materials with a high resistance (Mega Ω) be utilized as a dielectric layer. Preferably materials with a volume resistivity of about 10⁸ ohm-cm or greater is utilized. If lower resistivity materials are utilized a greater thickness of the dielectric layer may be utilized to form a dielectric layer with the desired properties. Dielectric materials can be evaluated by their dielectric strength which is defined as the maximum voltage required to produce a dielectric breakdown through the material and is expressed as Volts per unit thickness. This is rated in kV. Dielectric materials can be evaluated also by their “partial discharge” rating. This is generally 600 volts for the US and 1000 volts for Europe. This test is generally used for back sheets and dielectric layers within a device. These dielectric layers may also reduce the requirements of other materials in the photovoltaic device, such as the polymeric frame, first environmental barrier, or second environmental protection layer. In the preferred embodiment, these layers have a RTI (Relative Thermal Index) as determined by the test procedure detailed in UL 746B. These dielectric layers may be constructed of materials such as nylon, polycarbonate, phenolic, polyetheretherketone, polyethylene terephthalate, polyethylene and other known dielectrics.

In a preferred embodiment, one or more of the layers may act as an additional barrier layer (supplemental barrier layer), protecting the adjoining layers above from environmental conditions and from physical damage that may be caused by any features of the structure on which the multi-layer laminate structure is subjected to (e.g. for example, irregularities in a roof deck, protruding objects or the like). It is also contemplated that a supplemental barrier layer could provide other functions, such as thermal barriers, thermal conductors, adhesive function, dielectric layer, etc. The supplemental barrier sheet may be a single material or a combination of several materials, for example, it may include a scrim or reinforcing material. In a preferred embodiment, the supplemental barrier sheet material may be at least partially moisture impermeable and also range in thickness from about 0.25 mm to 10.0 mm, more preferably from about 0.5 mm to 2.0 mm, and most preferably from about 0.8 mm to 1.2 mm. It is preferred that this layer exhibit elongation at break of about 20% or greater (as measured by ASTM D882-09); tensile strength or about 10 MPa or greater (as measured by ASTM D882-09); and tear strength of about 35 kN/m or greater (as measured with the Graves Method). Examples of preferred barrier layer materials include thermoplastic polyolefin (“TPO”), thermoplastic elastomer, olefin block copolymers (“OBC”), natural rubbers, synthetic rubbers, polyvinyl chloride, and other elastomeric and plastomeric materials. Alternately the protective layer could be comprised of more rigid materials so as to provide additional structural and environmental protection. Additional rigidity may be desirable so as to improve the coefficient of thermal expansion of the multi-layer laminate structure and maintain the desired dimensions during temperature fluctuations. Examples of protective layer materials for structural properties include polymeric materials such polyolefins, polyester amides, polysulfone, acetel, acrylic, polyvinyl chloride, nylon, polycarbonate, phenolic, polyetheretherketone, polyethylene terephthalate, epoxies, including glass and mineral filled composites or any combination thereof.

One or more of the layers may be constructed of any number of photovoltaic cells or connected cell assemblies, which may be commercially available today or may be selected from some future developed photovoltaic cells. Any known photovoltaic cell material that functions to convert solar energy to electrical energy may be utilized herein. According to one embodiment, it is contemplated that the electrical circuit assembly is part of this layer of the multi-laminate structure and is further described in a following sections of this disclosure. The electrical circuit assembly is connected to the connector assembly so as to facilitate transfer of the electrical energy generated by the photovoltaic cells to other components of the system, for instance other photovoltaic devices, edge elements, wiring adapted for transporting the electrical energy to an inverter.

Photovoltaic cells or cell assemblies function to convert light energy into electrical energy and transfer the energy to and from the device via connector assemblies. The photoactive portion of the photovoltaic cells may comprise material which converts light energy to electrical energy. Examples of such material includes crystalline silicon, amorphous silicon, CdTe, GaAs, dye-sensitized solar cells (so-called Gratezel cells), organic/polymer solar cells, or any other material that converts sunlight into electricity via the photoelectric effect. Preferably the photoactive layer comprises IB-IIIA-chalcogenide, such as IB-IIIA-selenides, IB-IIIA-sulfides, or IB-IIIA-selenide sulfides. More specific examples include copper indium selenides, copper indium gallium selenides, copper gallium selenides, copper indium sulfides, copper indium gallium sulfides, copper gallium selenides, copper indium sulfide selenides, copper gallium sulfide selenides, and copper indium gallium sulfide selenides (all of which are referred to herein as CIGSS). These can also be represented by the formula Culn(1−x)GaxSe(2−y)Sy where x is 0 to 1 and y is 0 to 2. The copper indium selenides and copper indium gallium selenides are preferred. Additional electroactive layers such as one or more of emitter (buffer) layers, conductive layers (e.g. transparent conductive layers) and the like as is known in the art to be useful in CIGSS based cells are also contemplated herein. These cells may be flexible or rigid and come in a variety of shapes and sizes, but generally are fragile and subject to environmental degradation. In a preferred embodiment, the photovoltaic cell assembly is a cell that can bend without substantial cracking and/or without significant loss of functionality. Exemplary photovoltaic cells are taught and described in a number of patents and publications, including U.S. Pat. No. 3,767,471, U.S. Pat. No. 4,465,575, US20050011550A1, EP841706A2, US20070256734A1, EP1032051A2, JP2216874, JP2143468, and JP10189924A, incorporated herein by reference in their entirety for all purposes.

### Polymeric Frame

The photovoltaic devices comprise a polymeric frame that functions to contain the components of the structure without interfering with the ability of the photovoltaic cells to convert solar energy to electrical energy. The polymeric frame functions as the main structural carrier for the PV device and may be constructed in a manner consistent with this. For example, it can essentially function as a polymeric framing material. The polymeric frame may function to hold some or all of the parts of the photovoltaic structure together. The polymeric frame may function to encapsulate and protect certain parts of the structure. The polymeric frame is preferably flexible and allows the photovoltaic devices to conform to the irregularities of building surfaces. In some embodiments the polymeric frame forms the structure by which the device can be attached to a structure. The polymeric frame can be adapted to form the base structure such that the photovoltaic device appears and functions like known roofing systems. For instance the polymeric frame can form a shingle like or tile like structure. The polymeric frame may be a compilation of components/assemblies, but is preferably generally a polymeric article that is formed by any known fabrication technique that facilitates forming a structure that achieves the recited functions. The polymeric frame can be formed by injection molding, compression molding, reaction injection molding, resin transfer molding, thermal forming, and the like. Preferably the polymeric frame can be formed by injecting a polymer (or polymer blend) into a mold (with or without inserts such as the multi-layer laminate structure or the other component(s)), for example as disclosed in WO 2009/137,348, incorporated herein by reference.

The polymeric frame may comprise any material that allows the polymeric frame to perform one or more of the recited functions. Preferably, the CLTE of the polymeric frame composition closely matches the CLTE of other layers of the system for instance the environmental protective layer (or in some cases of the entire structure). Preferably the compositions that make up the polymeric frame also exhibit a coefficient of linear expansion (“CLTE”) of about 0.5×10-6 mm/mm° C. to about 140×10-6 mm/mm° C., preferably of about 3×10-6 mm/mm° C. to about 50×10-6 mm/mm° C., more preferably from about 5×10-6 mm/mm° C. to about 30×10-6 mm/mm° C., and most preferably from about 7×10-6 mm/mm° C. to about 25×10-6 mm/mm° C. Preferably the CLTE of the composition making up the polymeric frame disclosed herein are also characterized by a coefficient of linear thermal expansion (CLTE) is within factor of 20, more preferably within a factor of 15, still more preferably within a factor of 10, even more preferably within a factor of 5, and most preferably within a factor of 2 of the CLTE of the protective layer (or entire structure). For example, if the environmental protective layer has a CLTE of 9×10-6 mm/mm° C., then the CLTE of the polymeric frame composition is preferably from 180×10-6 mm/mm° C. to 0.45×10-6 mm/mm° C. (a factor of 20); more preferably from 135×10-6 mm/mm° C. to 0.6×10-6 mm/mm° C. (a factor of 15); still more preferably from 90×10-6 mm/mm° C. to 0.9×10-6 mm/mm° C. (a factor of 10); even more preferably from 45×10-6 mm/mm° C. to 1.8×10-6 mm/mm° C. (a factor of 5) and most preferably from 18×10-6 mm/mm° C. to 4.5×10-6 mm/mm° C. (a factor of 2).

For some embodiments of the photovoltaic devices disclosed herein, the environmental shield layer comprises a glass barrier layer. If the photovoltaic devices include a glass layer, the CLTE of the polymeric frame composition is preferably less than 80×10-6 mm/mm° C., more preferably less than 70×10-68 mm/mm° C., still more preferably less than 50×10-6 mm/mm° C., and most preferably less than 30×10-6 mm/mm° C. Preferably, the CLTE of the polymeric frame composition is greater than 5×10-6 mm/mm° C.

In a preferred embodiment, the polymeric frame may comprise a filled or unfilled moldable polymeric material. Any polymeric material that facilitates the polymeric frame performing its recited function may be utilized for the polymeric frame. Exemplary polymeric materials include polyolefins, styrene acrylonitrile (SAN) acrylonitrile butadiene styrene, hydrogenated styrene butadiene rubbers, polyester amides, polyether imide, polysulfone, acetel, acrylic, polyvinyl chloride, nylon, polyethylene terephthalate, polycarbonate, thermoplastic and thermoset polyurethanes, synthetic and natural rubbers, epoxies, acrylics, polystyrene, or any combination thereof. Fillers (preferably up to about 50% by weight) may include one or more of the following: colorants, fire retardant (FR) or ignition resistant (IR) materials, reinforcing materials, such as glass or mineral fibers, surface modifiers. The polymeric materials may also include anti-oxidants, release agents, blowing agents, and other common plastic additives. In a preferred embodiment, glass fiber filler is used. The glass fiber preferably has a fiber length (after molding) ranging from about 0.1 mm to about 2.5 mm with an average glass length ranging from about 0.7 mm to 1.2 mm.

In a preferred embodiment, the polymeric frame materials exhibit a melt flow rate of about 5 g/10 minutes or greater, more preferably about 10 g/10 minutes or greater. The melt flow rate is preferably 100 g/10 minutes or less, more preferably about 50 g/10 minutes or less and most preferably about than 30 g/10 minutes or less. The melt flow rate of compositions can be determined by test method ASTM D1238-04, “REV C Standard Test Method for Melt Flow Rates of Thermoplastics by Extrusion Plastometer”, 2004 Condition L (230° C./2.16 Kg).

The polymeric frame materials preferably exhibit flexural moduli of about 500 MPa or greater, more preferably about 600 MPa or greater and most preferably about 700 MPa or greater. Where the multi-layer laminate structure includes a glass layer, the flexural modulus is preferably about 1000 or greater and about 7000 MPa or less. According to the second embodiment, the flexural modulus is about 1500 MPa or less, more preferably about than 1200 MPa or less, most preferably about than 1000 MPa or less. The flexural modulus of polymeric frame material may be determined by test method ASTM D790-07 (2007) using a test speed of 2 mm/min. Preferably the polymeric frame materials exhibit a coefficient of linear expansion (“body CLTE”) of about 25×10−6 mm/mm° C. to 70×10−6 mm/mm° C., more preferably of about 27×10−6 mm/mm° C. to 60×10−6 mm/mm° C., and most preferably from about 30×10−6 mm/mm° C. to 40×10−6 mm/mm° C. The polymeric frame material may also be characterized as exhibiting a Young's Modulus @-40° C.=7600 MPa+/−20%; @23° C.=4200 MPa+/−20%; and @85° C.=2100 MPa+/−20%.

The polymeric frame materials may be characterized as having both an RTI Electrical, an RTI Mechanical Strength, and an RTI Mechanical Impact rating, each of which is about 85° C. or greater, preferably about 90° C. or greater, more preferably about 95° C. or greater, still more preferably about 100° C. or greater, and most preferably about 105° C. or greater. RTI (Relative Thermal Index) is determined by the test procedure detailed in UL 746B (Nov. 29, 2000). Because RTI is an expensive and time-consuming test, a useful proxy for guiding the skilled artisan in selecting useful compositions is the melting point, as determined by differential scanning calorimetry (DSC). It is preferred that for the compositions set forth as useful herein, no melting point is seen at temperatures less than 160° C. in differential scanning calorimetry for a significant portion of the composition and preferably no melting point is seen under 160° C. for the entire composition. The Differential Scanning Calorimetry profiles were determined by test method ASTM D7426-08 (2008) with a heating rate of 10° C./min. If a significant fraction of the injection molding composition melts at temperatures below 160° C., it is unlikely that the composition will pass the UL RTI tests 746B for Electrical, Mechanical Strength, Flammability, and Mechanical Impact with a high enough rating to adequately function when used in the PV device 1000. The polymeric frame may comprise any shapes and size that facilitates it performing its recited function. For example, it may be square, rectangular, triangular, oval, circular or any combination thereof.

### Electrical Circuit Assembly

The photovoltaic devices comprise electrical (electronic) circuit assemblies adapted to collect electrical energy generated by the photovoltaic cells and to transmit the electrical energy through the photovoltaic device. Any electrical circuit system known in the art for collecting and transmitting electrical energy within a photovoltaic system may be utilized herein. The electrical circuit assembly is connected to connector assemblies which are adapted to connect the photovoltaic device with external devices, such as adjacent photovoltaic devices, edge sections or an electrical system adapted to transmit electrical energy for use (inverter). The electrical circuit assembly comprises conductors in contact with photovoltaic cells to collect the electrical energy converted form solar energy. Preferably such conductive collectors are applied to the surface of the photovoltaic cells in pattern. Where the photovoltaic devices comprise more than one photovoltaic cell the devices further comprise conductive connectors that connect the conductive collectors so as to transmit the electrical energy through the device. The electrical connectors can be in the form of bus bars, traces, conductive foil or mesh and the like. Generally the electrical connectors are connected with the connector assemblies. Exemplary electrical circuit assemblies are disclosed in WO 2012/033657 and WO 2012/037191 incorporated herein by reference.

### Connector Assembly

The devices comprise one or more connector assemblies which address one or more of the needs described in this disclosure. Functionally, the assemblies function as the conduit/bridge for electricity to move to and from the photovoltaic devices. The one or more connector assemblies comprise i) a connector housing having an inboard portion, an outboard portion and a header that separates the Inboard portion from the outboard portion; ii) at least one electrical conductor having one end located at least partially within the outboard portion of the one or more connector assemblies and a second end protruding from the inboard portion of the housing wherein the second end is connected to one of the electrical circuit assemblies, iii) a sealant disposed about at least a portion of the inboard portion of the connector housing; and iv) a rigid case disposed about and containing the sealant. The one or more connector assemblies and the one or more electrical circuit assemblies are at least partially mechanically interfaced with the polymeric frame. This mechanical interface may be provided by encasing portions of the one or more connector assemblies or the one or more electrical assemblies in a polymeric frame, preferably through an injection overmolding of the polymeric frame, adhesive attachment of the polymeric frame, or other assembly techniques. The polymeric frame bonds to the surface of one or more of the components it is in contact with. This bonding can be recognized as a mechanical interface. The connector assembly comprises a housing adapted to house the functional components and provide structure to the connector. Inboard as used herein means the portion of a connector housing located away from the edge of the polymeric frame and is preferably encased in the polymeric frame. The inboard portion functions to contain and protect internal parts of the connector assembly. The outboard portion of a connector housing is disposed at or near the edge of the polymeric frame and may protrude from the polymeric frame. The outboard portion of a connector housing functions to house and protect the conductor element adapted to connect the photovoltaic devices with external devices and serves as a mating structure for connectors of adjacent devices or external connectors. The outboard portion of a connector assembly may be a female connector, male connector or combination thereof. The header separates the outboard and inboard portions. Adjacent devices can be adjacent photovoltaic devices, edge pieces and the like.

The connector housings may be comprised of somewhat rigid materials that will hold up to the conditions of use. Exemplary materials include thermoplastics, thermosets, metals, ceramics, and composites. Not surprisingly, the connector housings are preferably constructed of electrically non-conductive materials (having dielectric properties) and the electrical conductor of electrically conductive materials. Preferred non-conductive materials may be organic or inorganic materials. Examples of preferred polymeric materials include thermoplastic and thermosetting materials such as, for example, filled or unfilled olefins, styrenics, polypropylene, polycarbonate, acrylonitrile butadiene styrene, polybutylene terephthalate, polyphenylene oxide, polyphenylene ether, polyphthalamide, polyphenylene sulfide, polyamide, polyarylamide, polymeric elastomers, natural or synthetic rubber, ceramic, or any combination thereof. Preferred conductive materials include plated or un-plated metals (e.g. silver, tin, steel, gold, aluminum, copper, brass, or any combination thereof) and/or conductive polymers. The housing may further comprise a locating element adapted to align the connector with an external connector or device. The housing may further comprise a securing system for holding the connector assembly and consequently the photovoltaic device to an external connector or device. Such securing system can comprise any known securing system (retention aid) that performs the function, for example one or more discontinuities in the housing surface that facilitates alignment with an external connector or device, for example grooves, ribs, snap fits, mating holes and protrusions, and the like.

The at least one electrical conductor functions to conduct electricity through the connector housing from the electrical circuit assembly to an external device. The electrical conductor in the inboard portion overlaps and is functionally electrically connected to the electrical circuit assembly at a connection zone. The connection zone could be a single point or a span ranging from a few millimeters to a few centimeters. The electrical connection between the connector and the electrical circuit assembly may be facilitated by any known technique, for example: welding; soldering; crimping; the use of conductive adhesives and the like.

The connector assembly comprises a sealant adapted to seal about the electrical conductor and/or portions of the connector housing so as to prevent interference with the transmission of electrical energy out of the photovoltaic device. Preferably the sealant is located about the Inboard portion of the connector housing and optionally one or both of a portion of the electrical conductor and the connection of the electrical conductor with the electrical circuit assembly. Disposed about the sealant and preferably containing the sealant is a rigid case. The sealant may comprise any material that performs the desired sealing function. The sealant can be a self-supporting material, a material that retains its shape, or a low viscosity material, a material that flows under conditions of use, or a combination thereof. The use of a rigid case provides flexibility in the choice of sealant materials. The sealant may function to aid in the isolation of the electrical conductor and/or electrical circuit assembly from outside environmental contaminants (e.g. air, water, dust and dirt, etc.) after the multi-layered laminate is combined with the polymeric frame. Of particular interest is the function of the sealant to perform this function in the situation where there is a separation or lack of an adhesive bond between the outside surface of the polymeric frame and the connector housing (e.g. due to mechanical or environmental stresses). In a preferred embodiment, the sealant may comprise an elastomeric material such as, silicone, polychloroprene, butadiene/acrylonitrile copolymer, EPDM rubber, polyurethane, polyisobutylene, styrene isoprene copolymers, styrene butadiene copolymers, epoxy resins, butyl rubber, fluorine containing elastomers, polyolefin elastomers, acrylic rubbers, polyester elastomers, polyamides, poly (ester amides), or poly (ether amides). The sealant may comprise copolymers, blends or any combination of the recited materials. Generally, it is preferred that the material have a hardness of from about 10 to 150 Shore A Durometer per ASTM D2240 00, more preferably from about 15 to 120, most preferably from about 20 to 100. One example of a commercially available barrier material is HelioSeal™ PVS 101 butyl from ADCO. The sealant exhibits the following desirable properties: it adheres to the connector header, adheres to the rigid case material, it adheres to the conductor and optionally adheres to the electrical assembly at a connection zone. In some embodiments it is preferably that the sealant does not melt during subsequent processing (e.g. molding or lamination).

The connector assembly further comprises a rigid case disposed about the sealant. The rigid case functions to provide one or more of the following functions: containment for the sealant such as during application, curing of the sealant, processing of either the multi-layer laminate assembly or processing relating to the attachment of the polymeric frame (for example via, overmolding); adhere to one or more of the sealant, the polymeric frame, or a surface of the multi-layer laminate assembly; provide dielectric properties for electrical insulation of the electrical circuit; and provide RTI rating for electrical, mechanical, or impact properties. In embodiments where another dielectric material is not in contact with one or more of the rigid case, the photovoltaic cells, the electric circuit assemblies and the connector assembly, the rigid case can function as a dielectric material so as to insulate one or more of the recited components. Preferably the rigid case functions to contain the sealant. Where the sealant is not self-supporting the rigid case holds the sealant in place. In a preferred embodiment the rigid case adheres to the materials of the photovoltaic device that surround or partially surround and are in contact with the rigid case, for instance a bonding layer and/or the polymeric frame. An advantage of utilizing the rigid case is that a sealant that does not adhere to a bonding layer (e.g. EVA) or the polymeric frame may be utilized as the rigid case contacts such elements. The rigid case preferably contains internal surfaces in contact with the sealant. The rigid case preferably contains external surfaces which may be in contact and/or bond to the polymeric frame and/or a bonding layer. The rigid case may further comprise one or more discontinuities on its external surface adapted to interlock with an encapsulant or the polymeric frame. Such discontinuities can function to improve the strength or the structural stability of the system. The discontinuities may be one or more indentations in or protrusions from the surface of the rigid case which are adapted to interlock with an encapsulant or the polymeric frame. The rigid case and the connector housing may comprise matching features for securing the rigid case to the connector housing, any features which accomplish this function may be utilized. One example includes providing projections from the connector housing and corresponding snap fit features on the rigid case that fit about the projections on the connector housing to hold the rigid case in place.

In one preferred embodiment, the material of the rigid case is selected such that it functions to create an adhesive joint between the rigid case, the connector housing, or both and the polymeric frame and/or encapsulant. Preferably this joint maintains its adhesive nature at least between about −40° C. and 85° C., more preferably −50° C. and 100° C.

The rigid case may comprise one or more parts wherein if there is more than one part, the parts are connected, or are completely separate. Preferably the one or more parts when applied to the elements to be sealed encase the sealant and the parts sealed therein. The one or more parts may further comprise elements to hold the rigid case together, for instance snap fits, interference fits, interlocks, and the like. The rigid case may be equipped with one or more ports for injecting a sealant composition into the rigid case.

### Assembly of Photovoltaic Devices

The photovoltaic devices may be assembled utilizing the following steps. Starting with one or more photovoltaic cells having an electrical circuit assembly applied thereto, the inboard end (second end) of the electrical conductor of one or more connector assemblies are connected to the electrical circuit assembly. The connection may be accomplished by welding, soldering, crimping or adhesively bonding the inboard end of the electrical conductors of the connector assembly to the electrical circuit assembly. Specific process steps for accomplishing the connection are well known in the art.

The sealant is contacted with a portion of the connector housing, optionally the second end of electrical conductor protruding from the inboard portion of the connector housing and optionally the connection between the electrical connector and one of the electrical circuit assemblies so as to form a seal about the contacted portions with the sealant. The sealant can be directly applied to the recited components, this generally is accomplished where the sealant is self-supporting. Self-supporting means the material has sufficient viscosity and modulus to maintain its shape after application, for instance where it is in the form of a sheet, strip or tape. Alternatively the sealant can be disposed in the rigid case and the rigid case with the sealant disposed therein is placed about the recited components. This embodiment can be utilized where the sealant is not self-supporting. Preferably the sealant surrounds those components to be sealed.

The rigid case and the sealant are contacted. The rigid case may be contacted with the sealant after the sealant is applied to the connector housing and optionally the second end of the electrical conductor and/or the connection point between the electrical conductor and the electrical circuit assembly. Alternatively, the sealant can be contacted with the rigid case and the rigid case is then placed about a portion of the connector housing, preferably an inboard portion, and optionally the second end of the electrical conductor and/or the connection point between the electrical conductor and the electrical circuit assembly. Preferably the rigid case entirely encases the sealant and the portion of the components the sealant is disposed about. In another embodiment the rigid case may be disposed about the the connector housing and optionally the second end of the electrical conductor and/or the connection point between the electrical conductor and the electrical circuit assembly and then the sealant is injected into the rigid case about the other components. The sealant can comprise a curable system. The sealant may be applied as described hereinbefore and then exposed to curing conditions. Curing may be achieved by exposing the sealant to heat, ultraviolet radiation, or an environment containing oxygen (such as air) or moisture. Alternatively the sealant may comprise a two part composition wherein the two parts are reactive with one another when contacted, for instance a two part epoxy or polyurethane system. Alternatively the sealant may be a hot melt adhesive that flows at elevated temperatures and is solid at ambient temperatures. A hot melt adhesive may be extruded in place and encased immediately upon extrusion. A curable adhesive may also be extruded in place and immediately encased. In the embodiment wherein the sealant is contacted with the rigid case prior to applying it to the other components, the rigid case may be adapted to have one or more containment sections for containing the sealant. In such embodiment the sealant can be a curable composition that is exposed to curing conditions prior to applying the sealant and rigid case to the other components and then applied to the other components before complete cure, that is during what may be referred to as the open time of the curable composition. The sealant may be an extrudable material that can be applied by extrusion techniques, for example the sealant can be a hot melt adhesive applied to the connector housing and then encased by the rigid case. The useful systems and conditions of cure are well known in the art.

After applying the sealant and the rigid case about the elements to be sealed, a bonding layer (encapsulant) may be applied to at least a portion of the connector assembly, preferably about rigid case. The bonding layer may be applied by lamination, extrusion about at least a portion of the connector assembly, film casting and the like. The polymeric frame can be applied over the a portion of the bonding layer, rigid case and/or the connector assembly, preferably over the rigid case. The polymeric frame may be formed by any known means of forming a polymeric material over a substrate. Examples of such processes include thermoforming, spraying, vibration welding, overmolding such as by injection molding, adhesive bonding, and the like. Preferably the polymeric frame is overmolded about the photovoltaic cells (which may be in the form of multilayer laminates), electrical circuit assembly and the connector assemblies. A preferred process is disclosed in U.S. Pat. Nos. 8,163,125 and 8,361,602 incorporated herein by reference in their entirety.

### Arrays

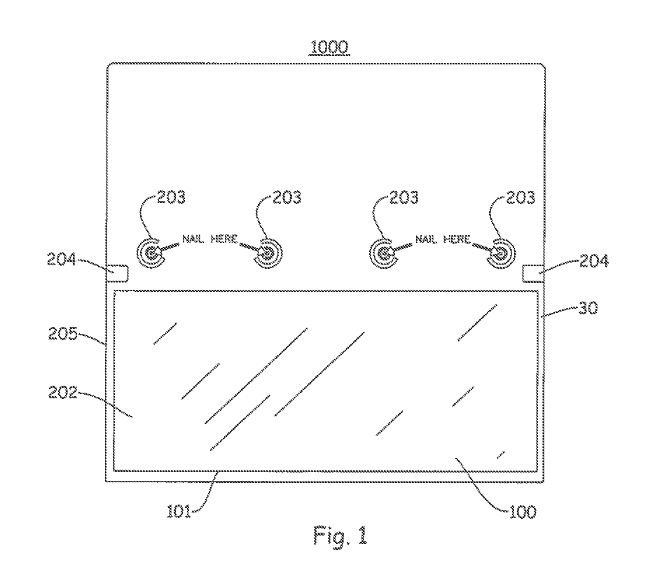

The photovoltaic devices of the invention may be utilized in arrays of photovoltaic devices. An array comprises a plurality of photovoltaic devices which are connected together electrically. The array comprises one or more rows of devices wherein each device is in a row is horizontally adjacent to one or more other devices. In a preferred embodiment the photovoltaic devices have a shingle like structure as illustrated in FIG. 1. The shingle like structure provides an active and inactive portion. The active portion comprises the portion of the device having the photovoltaic cells disposed thereon and in use this portion must be uncovered so as to be exposed to solar light. The inactive portion typically comprises the portion of the device that may be affixed to a structure using standard fastening systems. In a preferred embodiment the inactive portion is in direct contact with the building structure, such as roof boards or a membrane disposed on the roof boards. Preferably the photovoltaic devices are arranged such that the active portion is disposed on the inactive portion of a row photovoltaic devices applied below the row of devices having the relevant active portions. In another preferred embodiment the photovoltaic devices of each row are offset with respect to the photovoltaic device of the next adjacent row. In this embodiment a number of photovoltaic devices contact two photovoltaic devices of the next adjacent row. An array may further comprise edge components along the vertical edge of an array so as to provide a more aesthetically pleasing arrangement, that is even vertical edges of the array where the devices are offset. Such edge components may also function to connect adjacent rows electronically. Such edge components and arrays are disclosed in US Patent Applications 2011/0100436 and WO 2009/137,352 incorporated herein by reference in their entirety. The photovoltaic devices may be connected in series, in parallel or a combination thereof. The connector assemblies maybe used to form such connections. Preferably the connector assemblies are disposed or encased in the vertical edges of the photovoltaic devices. The encased connector assemblies may connect to the encased connector assemblies of adjacent photovoltaic devices. Alternatively a separate connection element may be used to connect the connector assemblies of adjacent connector assemblies. The outboard portion, first end, of the electrical conductor with the connector housing may be arranged in any manner that facilitates connection of the photovoltaic device to adjacent devices. Such arrangement can comprise a male connector or a female connector. Each photovoltaic device can have two of the same type of connectors, male or female, or one of each.

### FIGURES

FIG. 1 illustrates an exemplary photovoltaic device of the invention 1000 having a polymeric frame 30 disposed about a multilayer laminate 100 containing photoactive cells. The upper portion 201 is the inactive portion 201 and comprises the polymeric frame material 30. The upper portion 201 further comprises specific locations 203 for fastening the device 1000 to a building structure. Also shown is the active portion 202 comprising the multilayer laminate 100 with the polymeric frame 30 encasing the periphery 101 of the multilayer laminate 100. Also shown is the location 204 of the encased connector assemblies 10 (not shown) along the vertical edge 205 of the polymeric frame.

FIG. 2 illustrates an exploded view of the photovoltaic device 1000 of FIG. 1. Illustrated is the polymeric frame 30. In preferred embodiments the polymeric frame is formed about the other components, including the multilayer laminate 100 and therefore is not a separate component as shown in the exploded view. Also shown is the cut out or location 204 for the connector assembly and a connector assembly 10 and the electrical circuit assembly 5. Also shown is the environmentally protective layer 110, two bonding layers, 120 and 140, a photovoltaic layer 130 comprising a number of photovoltaic cells 132, an environmental protection (back) layer 150 and an additional barrier layer 160.

FIG. 3 illustrates a connector assembly 10 of the invention. The connector assembly 10 comprises a connector housing 12 having an inboard section 13 and an outboard section 15 separated by the header of the connector 17. Also shown is a projection 21 on the inboard section 13 of the connector housing adapted for forming an Interlock with the rigid case 40. The rigid case 40 encases the sealant material 20 which is disposed about electrical conductor 14 a portion of the inboard section 13 of the connector housing 12. The rigid case 40 has a projection 23 for forming an interlock with the projection 21 of the connector housing 12. The inboard portion of the electrical conductor 9 is connected to the electrical circuit assembly 5 at connection point 25. The rigid case 40 has an external surface 31 and internal surface 32 in contact with the sealant 20. The electrical conductor 15 has an outboard portion 11 located in the outboard portion 15 of the connector housing 12. An bonding layer 22 is disposed about the inboard portion 9 of the electrical conductor 15, the connection 25 and the electrical circuit assembly 5. A front insulator 24 and back insulator 26 are adjacent to the bonding layer 22. The polymeric frame 30 is disposed about the inboard portion of the connector housing 13, the rigid case 40 and the insulators 24 and 26. The rigid case 40 has a projection 27 adapted to interlock with the polymeric frame 30.

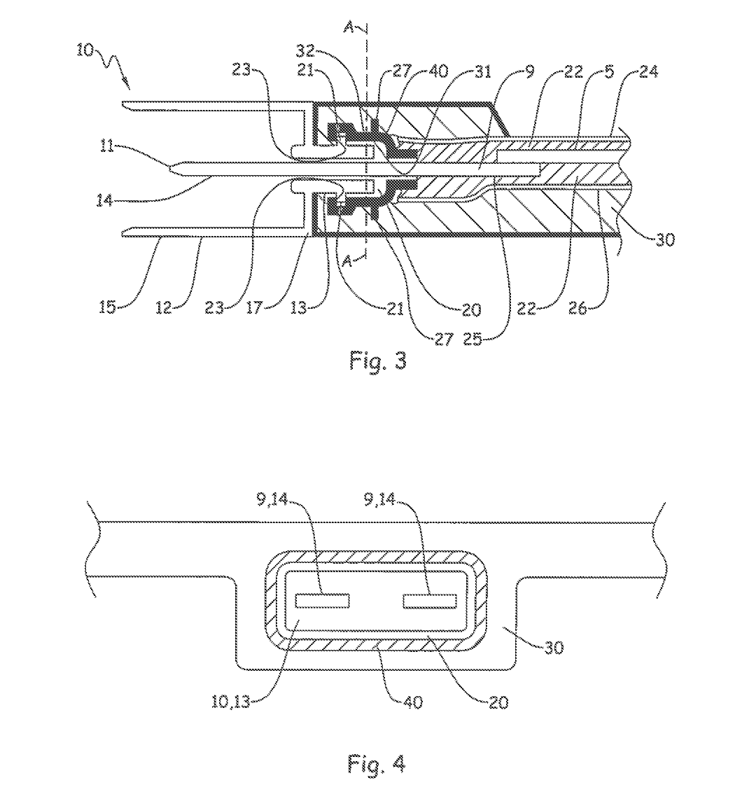

FIG. 4 shows the assembly of FIG. 3 along line A-A. Shown is the inboard section 9 of the electrical conductor 14 surrounded by the inboard portion 13 of the connector assembly 10. Surrounding the inboard portion 13 of the connector assembly 10 is the sealant 20. Containing the sealant 20 about the connector assembly 10 inboard portion 13 is the rigid case 40. Overmolded about the rigid case 40 is the polymeric frame 30.

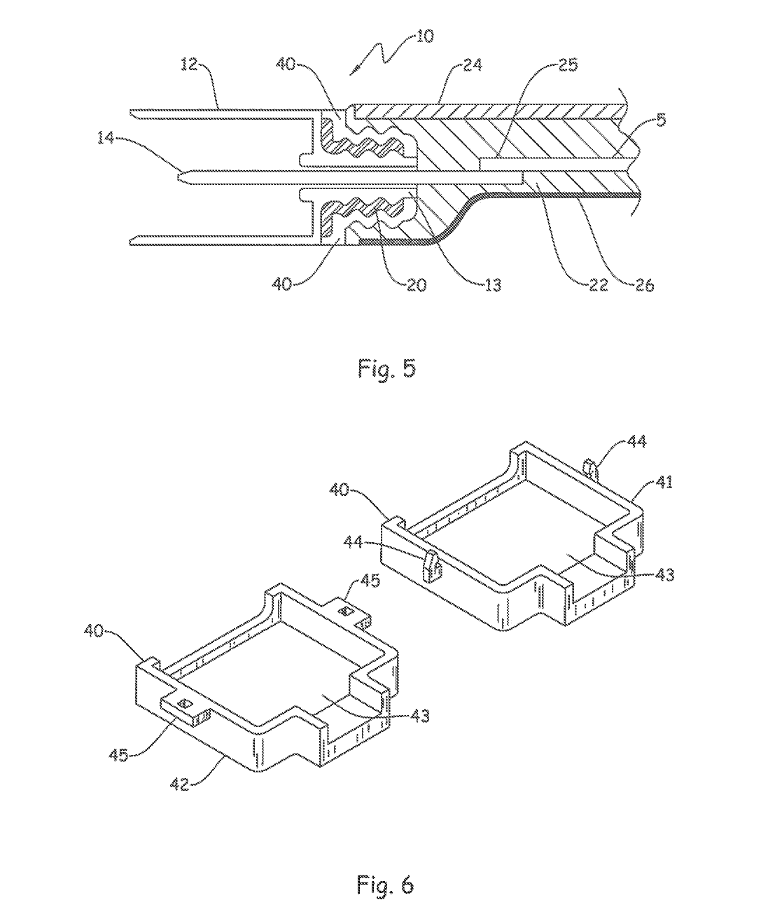

FIG. 5 shows another embodiment wherein the rigid case 40 and sealant are disposed about the inboard portion 13 of the connector housing 12. Also shown is the electrical conductor 14, the connection point 25, of the electrical conductor 14 to the electrical circuit assembly. Also shown are the bonding layer 22, front insulator 24 and back insulator 26.

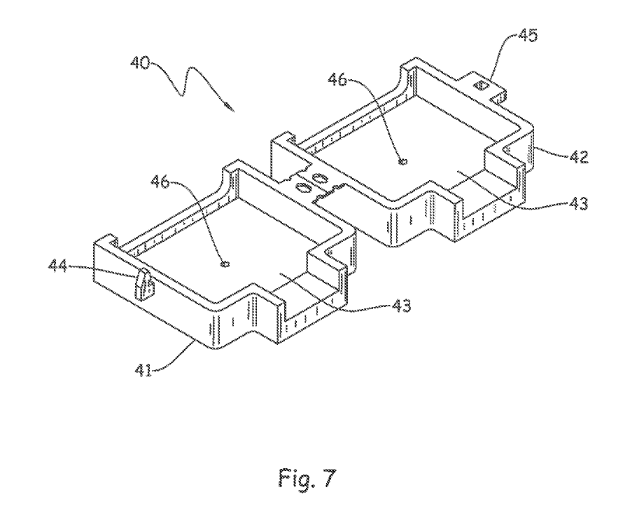

FIG. 6 illustrates a two part rigid case 40 having a first half 41 and a second half 42 and two sealant pockets 43. Also shown is a rigid case snap fit 44 and snap fit receiver 45. FIG. 7 illustrates a two part rigid case 40, wherein the two parts are connected, having a first half 41 and a second half 42 and two sealant pockets 43. Also shown is a rigid case snap fit 44 and snap fit receiver 45. Also shown is a port 46 for injection of sealant 20 (not shown) into the rigid case 40.

The invention may be further characterized by one or any combination of the features described herein, such as the rigid case 40 and one of the connector assemblies 10 each having corresponding features 21, 23 to create an interlocking fit between the rigid case 40 and the one or more connector assemblies 10 so as to form a region to contain the sealant 20; the rigid case 40 comprises internal surfaces 31 in contact with the sealant 20 and external surfaces 32 wherein at least a portion of the external surfaces 32 are in contact with the polymeric frame 30 and the external surfaces 32 have one or more discontinuities 27 that function to interlock with the polymeric frame 30; the one or more discontinuities 27 comprise one of more indentations in or projections from the external surfaces 32; the sealant 20 is in contact with at least a portion of the header 17 of one of the connector assemblies 10; the sealant 20 is in contact with the second end 9 of the electrical conductor 14 where it protrudes from the inboard portion 13 of the connector housing 12; the sealant 20 is in contact with the connection 25 of the electrical conductor 14 to one of the electrical circuit assemblies 5; the sealant 20 comprises a material capable of sealing to one or more of the connector housings 12 and the electrical conductor 14; the sealant 20 material is selected from the group consisting of silicone, polychloroprene, butadiene/acrylonitrile copolymer, EPDM rubber, polyurethane, polyisobutylene, styrene isoprene copolymers, styrene butadiene copolymers, epoxy resins, butyl rubber, fluorine containing elastomers, polyolefin elastomers, acrylic rubbers, polyester elastomers, polyamides, poly (ester amides), poly (ether amides), copolymers and blends thereof.

The method of the invention may be further characterized by one or any combination of the features described herein: applying an bonding layer 22 about the rigid case 40 about the sealant 20 and the electrical conductor 14 and connection 25 between the electrical conductor 14 and one or more of the electrical circuit assemblies 5 so as to bond to such elements; contacting the sealant with a portion of the connector housing 10, optionally the second end 9 of electrical conductor 14 protruding from the inboard portion 13 of the connector housing 12 and optionally the connection 25 between the electrical connector 14 and one of the electrical circuit assemblies 5 so as to form a seal about the contacted portions with the sealant 20; and thereafter encasing the sealant 20 with the rigid case 40; contacting a rigid case 40 with the sealant 20; thereafter contacting sealant 20 with a portion of the connector housing 10, optionally the second end 9 of electrical conductor 14 protruding from the inboard portion 13 of the connector housing 12 and optionally the connection 25 between the electrical connector 14 and one of the electrical circuit assemblies 5 so as to form a seal about the contacted portions with the sealant 20 and thereby encasing the sealant 20 with the rigid case 40 wherein the sealant 20 is disposed about a portion of the connector housing 10, optionally the second end 9 of electrical conductor 14 protruding from the Inboard portion 13 of the connector housing 12 and optionally the connection 25 between the electrical connector 14 and one of the electrical circuit assemblies 5 so as to form a seal about the contacted portions with the sealant 20; the polymeric frame 30 is formed by overmolding polymeric material about the one or more connector assemblies 10 and the one or more electrical circuit assemblies 5; the sealant 20 is contacted with the rigid case 40 by injecting the sealant 20 into a port 46 of the rigid case 40 wherein the rigid case 40 is disposed about and encloses a portion of the connector housing 10, optionally the second end 9 of electrical conductor 14 protruding from the inboard portion 13 of the connector housing 12 and optionally the connection 25 between the electrical connector 14 and one of the electrical circuit assemblies 5.

Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. Therefore, the following claims should be studied to determine the true scope and content of the invention. Unless otherwise stated, all ranges include both endpoints and all numbers between the endpoints. The use of “about” in connection with a range applies to both ends of the range. The disclosures of all articles and references, including patent applications and publications, are incorporated by reference for all purposes. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A photovoltaic device comprising:
a polymeric frame;
one or more photovoltaic cells that include one or more electrical circuit assemblies; and
one or more connector assemblies comprising:
i) a connector housing having an inboard portion, an outboard portion, and a header that separates the inboard portion from the outboard portion,
ii) and at least one electrical conductor having one end located at least partially within the outboard portion of the connector housing and a second end protruding from the inboard portion of the connector housing so that the second end of the at least one electrical conductor is connected to one of the one or more electrical circuit assemblies forming a connection,
iii) a sealant disposed about at least a portion of the inboard portion of the connector housing; and
iv) a rigid case disposed about and containing the sealant and a portion of the inboard section of the connector header so that the rigid case contains the sealant in place;
wherein the one or more connector assemblies, and the one or more electrical circuit assemblies are at least partially encased in the polymeric frame, and the polymeric frame is in contact with at least a portion of the rigid case.

2. The photovoltaic device according to claim 1, wherein the rigid case and one of the connector assemblies each have corresponding features to create an interlock between the rigid case and the one or more connector assemblies so as to form a region to contain the sealant.

3. The photovoltaic device according to claim 1, wherein the rigid case comprises internal surfaces in contact with the sealant, and external surfaces,
wherein the at least a portion of the rigid case in contact with the polymeric frame is the external surfaces, and the external surfaces have one or more discontinuities that function to interlock with the polymeric frame.

4. The photovoltaic device according to claim 3, wherein the one or more discontinuities comprise one of more indentations in or projections from the external surfaces.

5. The photovoltaic device according to claim 1, wherein the sealant is in contact with at least a portion of the header of one of the connector housing.

6. The photovoltaic device according to claim 1, wherein the sealant is in contact with the second end of the electrical conductor where the electrical conductor protrudes from the inboard portion of the connector housing.

7. The photovoltaic device according to claim 1, wherein the sealant is in contact with the connection of the electrical conductor to one of the electrical circuit assemblies.

8. The photovoltaic device according to claim 1, wherein the polymeric frame is disposed about a multilayer laminate structure comprising the photovoltaic cells.

9. The photovoltaic device according to claim 1, wherein the sealant comprises a material capable of sealing to one or more of the connector housings and the electrical conductor.

10. The photovoltaic device according to claim 1, wherein the sealant is selected from the group consisting of silicone, polychloroprene, butadiene/acrylonitrile copolymer, EPDM rubber, polyurethane, polyisobutylene, styrene isoprene copolymers, styrene butadiene copolymers, epoxy resins, butyl rubber, fluorine containing elastomers, polyolefin elastomers, acrylic rubbers, polyester elastomers, polyamides, poly (ester amides), poly (ether amides), copolymers and blends thereof.

11. The photovoltaic device according to claim 1, wherein the photovoltaic cells are contained in a multilayer laminate structure.

12. A method comprising;
a) connecting at least one of one or more electrical conductors of one or more connector assemblies to one or more electrical circuit assemblies of one or more photovoltaic cells;
wherein the one or more connector assemblies comprise:
a connector housing having:
an inboard portion,
an outboard portion, and
a header that separates the inboard portion from the outboard portion, and the at least one electrical conductor having one end located at least partially within the outboard portion of the connector housing and a second end protruding from the inboard portion of the connector housing that is connected to the electrical circuit assembly;
b) contacting a portion of the connector housing with sealant, optionally contacting the second end of electrical conductor protruding from the inboard portion of the connector housing and optionally the connection between the electrical connector and one of the electrical circuit assemblies with sealant, so as to form a seal about the portions contacted with the sealant;
c) contacting a rigid case with the sealant;
d) encasing the sealant and a portion of the inboard portion of the connector header with a rigid case so that the rigid case contains the sealant in place; and
e) forming a polymeric frame about a portion of the one or more photovoltaic cells and the one or more connector assemblies so that the polymeric frame is in contact with at least a portion of the rigid case.

13. The method of claim 12, wherein the sealant is encased by the rigid case after the sealant is contacted with the portion of the connector housing.

14. The method of claim 12, wherein the rigid case is contacted with the sealant before the portion of the connector housing is contacted with the sealant.

15. The method of claim 12, wherein the sealant is contacted with the rigid case by injecting the sealant into a port of the rigid case wherein the rigid case is disposed about and encloses a portion of the connector housing, optionally the second end of electrical conductor protruding from the inboard portion of the connector housing and optionally the connection between the electrical connector and one of the electrical circuit assemblies.

16. (canceled)
